(19) United States
(12) Patent Application Publication
(10) Pub. No.: US 2024/0067210 A1
(43) Pub. Date: Feb. 29, 2024

(54) DRIVING CONTROL SYSTEM FOR VEHICLE, AND DRIVING CONTROL APPARATUS FOR VEHICLE

(71) Applicant: SUBARU CORPORATION, Tokyo (JP)

(72) Inventors: Hajime OYAMA, Shibuya-ku, Tokyo (JP); Kengo KOBAYASHI, Minato-ku, Tokyo (JP); Norikazu EBISAWA, Minato-ku, Tokyo (JP); Yasuhiro TAKAHASHI, Minato-ku, Tokyo (JP); Hiroaki KAWAMURA, Minato-ku, Tokyo (JP); Masaru NAKANISHI, Minato-ku, Tokyo (JP)

(73) Assignee: SUBARU CORPORATION, Tokyo (JP)

(21) Appl. No.: 18/270,022

(22) PCT Filed: Dec. 23, 2021
(86) PCT No.: PCT/JP2021/048013

§ 371 Date: Jun. 28, 2023

(30) Foreign Application Priority Data
Dec. 28, 2020 (JP) 2020-219596

(51) Int. Cl. B60W 60/00; B60W 30/09; B60W 30/095

(52) U.S. Cl. CPC B60W 60/001; B60W 30/09; B60W 30/0956; B60W 2556/45

(57) ABSTRACT

A driving control system 1 includes a camera unit 11 and a transceiver 18 which are mounted to a vehicle 5. The driving control system 1 also includes a transceiver 74, an information recognition_ECU 72 which recognizes road traffic information based on first road traffic detection information received by the transceiver 74 through the transceiver 18, and a traveling_ECU 73 which computes control information for the vehicle 5 based on the road traffic information, which are provided to a traffic control apparatus 70 disposed in each predetermined traffic control area. The driving control system 1 also includes an E/G_ECU 23, a PS_ECU 24, and a BK_ECU 25 which are mounted to the vehicle 5 and execute driving control based on the control information received by the transceiver 18 through the transceiver 74.

### TECHNICAL FIELD

The technology relates to a driving control system for vehicle and a driving control apparatus for vehicle which execute driving control such as avoidance control with respect to a collision with an obstacle for vehicle.

### BACKGROUND ART

In recent years, to aim for reducing burden of a driving operation by a driver and also for achieving an improvement in safety, a driving control apparatus which assists the driving operation by the driver has been put into practical use in a vehicle such as an automobile. In such a driving control apparatus, various types of technologies regarding a traveling control mode in which steering assist control and acceleration and deceleration control are executed on a premise of a proactive driving operation by the driver, and a traveling control mode (so-called automatic driving mode) in which a vehicle is caused to travel without a necessity of the driving operation by the driver have been developed (for instance, see Japanese Unexamined Patent Application Publication No. 2019-172113).

Traveling control by the driving control apparatus is basically achieved with an adaptive cruise control (ACC) function, an active lane keep centering (ALKC) control function, and the like. Then, by such traveling control, an inter-vehicle distance to a preceding vehicle can be maintained, and the vehicle can be caused to automatically travel along a traveling lane.

In addition, in the driving control apparatus, autonomous emergency braking ((AEB): collision damage reducing breaking) control for avoiding a collision with an obstacle has been put into practical use. In this autonomous emergency braking control, when a traveling environment recognition apparatus using autonomous sensors such as a camera and a radar recognizes an obstacle such as a vehicle and a pedestrian ahead of an own vehicle, deceleration is applied until a relative velocity between the own vehicle and the obstacle becomes zero.

Furthermore, a technology of executing, when it is determined that a collision with an obstacle is not avoidable by the autonomous emergency braking control, autonomous emergency steering control for avoiding the collision with the obstacle has been put into practical use in the driving control apparatus.

These various types of driving control have been in a trend of sophistication towards completion of automatic driving control which does not require the driving operation by the driver even in case of an emergency and the like.

However, for the sophistication of the driving control, information around the own vehicle is to be acquired from multiple perspectives by using a plurality of autonomous sensors and the like. In addition, to recognize a traveling environment around the own vehicle based on the information acquired from the multiple perspectives and to compute control information for the driving control highly precisely, a control unit with high computation performance is to be used.

On the other hand, it is desirable that the driving control related to the safety, in particular, such as the avoidance control with respect to the collision with the obstacle among various types of the driving control, is widely deployed to vehicles of various types of specifications. Furthermore, latest control programs and the like which have been developed around the clock are desirably applied at any time to the computation of the control information such as the driving control related to the safety as described above.

Aspects of the technology have been made in view of the above-described circumstances, and it is desirable to provide a driving control system for vehicle with which latest driving control can be deployed to vehicles of various types of specifications without mounting a complicated system to the vehicles, and a driving control apparatus for vehicle.

### DISCLOSURE OF INVENTION

### Means for Solving the Problem

A driving control system for vehicle according to an aspect of the technology includes a first road traffic detection information acquisition unit which is provided to a movable object and configured to acquire first road traffic detection information, a first communication device provided to the movable object, a second communication device provided to a traffic control apparatus disposed in each traffic control area, a road traffic information recognition unit which is provided to the traffic control apparatus and configured to recognize road traffic information based on the first road traffic detection information received by the second communication device through the first communication device, a control information computation unit which is provided to the traffic control apparatus and configured to compute, as control information for a vehicle present in the traffic control area and based on the road traffic information, at least a target value or a control instruction value of control for the vehicle to urgently avoid a collision with an obstacle, and a driving control execution unit which is mounted to the vehicle and configured to execute driving control based on the control information received by the first communication device through the second communication device.

A driving control apparatus for vehicle according to another aspect of the technology includes a road traffic detection information acquisition unit configured to acquire road traffic detection information, a communication device configured to transmit the road traffic detection information to a traffic control apparatus disposed in each traffic control area and to receive control information computed in the traffic control apparatus so as to include at least a target value or a control instruction value of control for a vehicle to urgently avoid a collision with an obstacle, and a driving control execution unit configured to execute driving control based on the control information.

### BRIEF DESCRIPTION OF THE DRAWINGS

FIG. 1 is a schematic configuration diagram illustrating a driving control system for vehicle according to a first example of the technology.

FIG. 2 is an explanatory diagram illustrating a driving control apparatus for vehicle and a monitoring apparatus which are coupled to a traffic control apparatus by high speed wireless communication according to the first example.

FIG. 3 is an explanatory diagram illustrating a monitoring area of a stereo camera according to the first example.

FIG. 4 is an explanatory diagram illustrating road traffic detection information transmitted from the driving control apparatus for vehicle according to the first example.

FIG. 5 is an explanatory diagram illustrating road traffic detection information transmitted from the monitoring apparatus according to the first example.

FIG. 6 is a flowchart illustrating a communication control routine in a communication control unit of the driving control apparatus according to the first example.

FIG. 7 is a flowchart illustrating a communication control routine in a communication control unit of the traffic control apparatus according to the first example.

FIG. 8 is a flowchart illustrating a road traffic information recognition routine in a road traffic information recognition control unit of the traffic control apparatus according to the first example.

FIG. 9 is a flowchart (part 1) illustrating a control information computation routine in a traveling control unit of the traffic control apparatus according to the first example.

FIG. 10 is a flowchart (part 2) illustrating the control information computation routine in the traveling control unit of the traffic control apparatus according to the first example.

FIG. 11 is a configuration diagram illustrating a main part of a communication terminal according to a modification.

FIG. 12 is an explanatory diagram illustrating the driving control apparatus for vehicle, the communication terminal, and the monitoring apparatus which are coupled to the traffic control apparatus by the high speed wireless communication according to the modification.

FIG. 13 is a schematic configuration diagram illustrating a driving control system for vehicle using the communication terminal according to the modification.

FIG. 14 is a schematic configuration diagram illustrating a driving control system for vehicle according to a second example of the technology.

FIG. 15 is a flowchart illustrating a communication control routine in a communication control unit of a traffic control apparatus according to the second example.

### BEST MODE FOR CARRYING OUT INVENTION

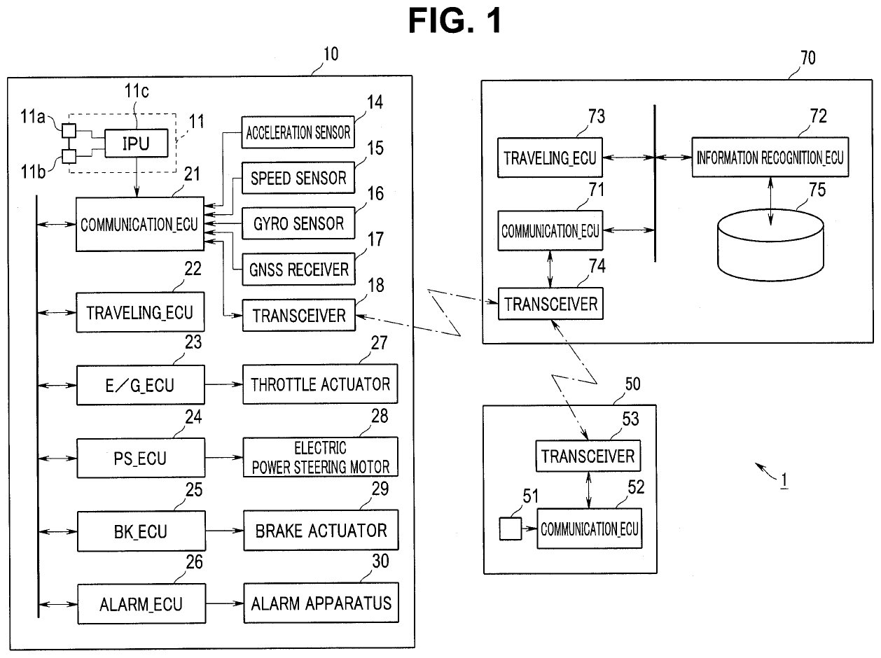

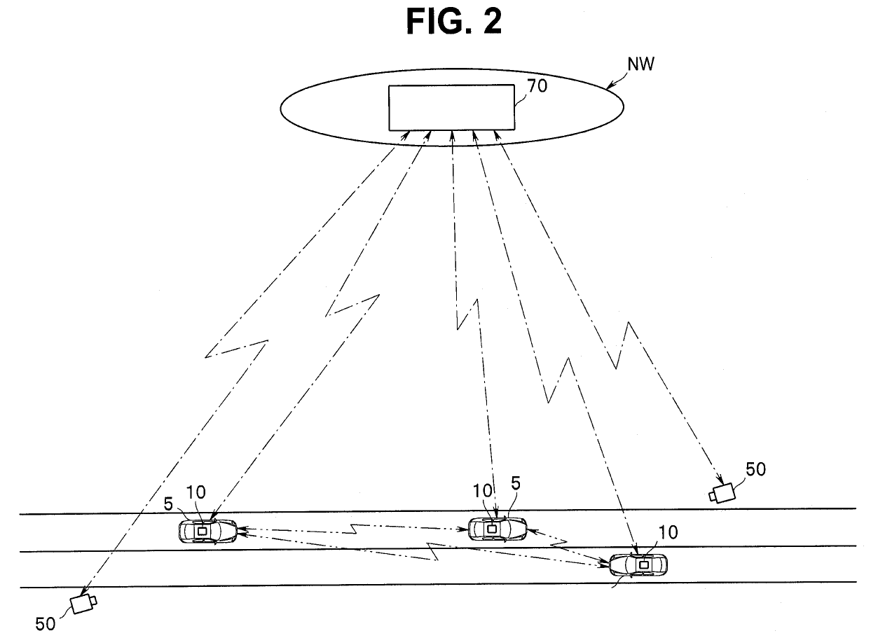

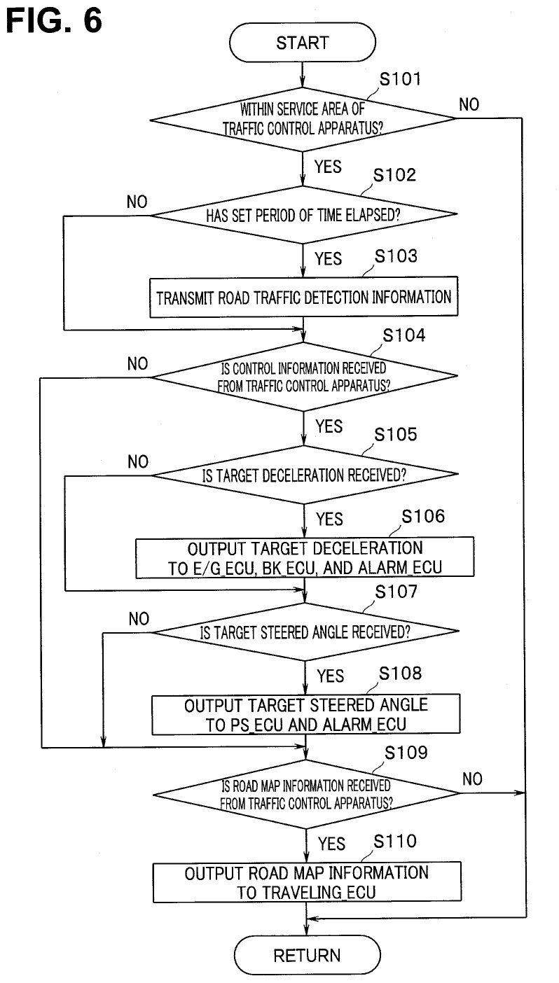

Hereinafter, examples of the technology will be described with reference to the drawings. FIG. 1 to FIG. 10 are related to a first example of the technology, in which FIG. 1 is a schematic configuration diagram illustrating a driving control system for vehicle, and FIG. 2 is an explanatory diagram illustrating a driving control apparatus for vehicle and a monitoring apparatus which are coupled to a traffic control apparatus by high speed wireless communication.

As illustrated in FIG. 1, a driving control system 1 in the present example includes a driving control apparatus 10 mounted to a vehicle 5 serving as a movable object, a monitoring apparatus 50 provided along a road, and a plurality of traffic control apparatuses 70 constituted by narrow area servers provided in a network environment NW.

The driving control apparatus 10 includes, for instance, a camera unit 11 as an autonomous sensor which detects a traveling environment outside the vehicle. The driving control apparatus 10 also includes a communication control unit (hereinafter, referred to as a “communication_ECU”) 21, a traveling control unit (hereinafter, referred to as a “traveling_ECU”) 22, an engine control unit (hereinafter, referred to as an “E/G_ECU”) 23, a power steering control unit (hereinafter, referred to as a “PS_ECU”) 24, a braking control unit (hereinafter, referred to as a “BK_ECU”) 25, and an alarm control unit (hereinafter, referred to as an “alarm_ECU”) 26. These control units 21 to 26 are coupled to each other via an in-vehicle communication line such as a controller area network (CAN).

The camera unit 11 is fixed, for instance, to the top center on a front side inside a vehicle cabin. The camera unit 11 includes, for instance, an onboard camera (stereo camera) constituted by a main camera 11a and a sub camera 11b, and an image processing unit (IPU) 11c.

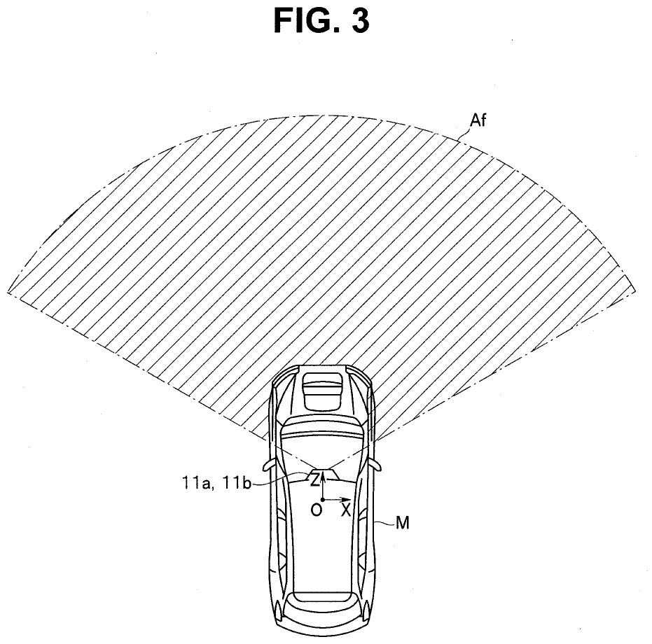

The main camera 11a and the sub camera 11b sense a real space ahead of the vehicle 5, for instance. That is, the main camera 11a and the sub camera 11b are disposed, for instance, at symmetric positions across the center in a width direction of the vehicle 5 to perform stereo imaging of a forward area Af (see FIG. 3) of the vehicle 5 from different points of view.

The IPU 11c processes image information of a forward traveling environment of the vehicle 5 which has been acquired through the stereo imaging by both the cameras 11a and 11b. Thus, the IPU 11c acquires distance information from a positional displacement amount of pixels representing corresponding targets in images on the left and right to generate image information (distance image information) including the distance information.

A transceiver 18 which enables wireless communication between the traffic control apparatus 70 and the driving control apparatus 10 of another vehicle 5 is coupled to the communication_ECU 21. The transceiver 13 is compatible with a highly reliable and low latency communication system (for instance, a 5th generation mobile communication system).

The camera unit 11 is coupled to an input side of the communication_ECU 21, and various types of sensors such as an acceleration sensor 14, a speed sensor 15, a gyro sensor 16, and a GNSS receiver 17 which are to be used to estimate a location (own vehicle location) of the vehicle 5 are also coupled to the input side of the communication_ECU 21. Herein, the acceleration sensor 14 detects a longitudinal acceleration and a lateral acceleration of the vehicle 5. The speed sensor 15 detects, for instance, respective rotational speeds of front, rear, left, and right wheels. The gyro sensor 16 detects an angular velocity or an angular acceleration of the vehicle 5. The GNSS receiver 17 receives positioning signals emitted from a plurality of positioning satellites.

The communication_ECU 21 generates road traffic detection information (first road traffic detection information) including various types of information input from the camera unit 11, the acceleration sensor 14, the speed sensor 15, the gyro sensor 16, the GNSS receiver 17, and the like which have been described above. The communication_ECU 21 also transmits the generated first road traffic detection information to the traffic control apparatus 70 in every preset control cycle.

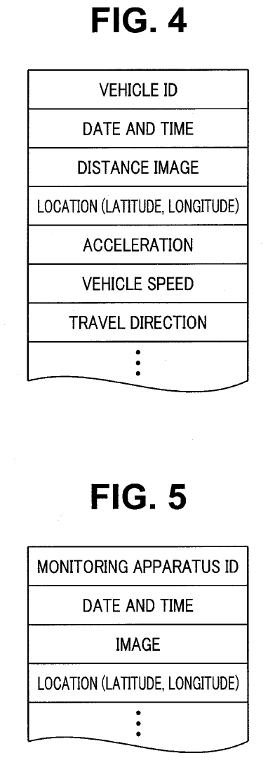

Specifically, the communication_ECU 21 generates, for instance, as illustrated in FIG. 4, the road traffic detection information (the first road traffic detection information) including a vehicle ID of the vehicle 5, a transmission date and time, a distance image, a location (a latitude and a longitude) of the vehicle 5, an acceleration of the vehicle 5, a speed of the vehicle 5, a travel direction of the vehicle 5, and the like. The communication_ECU 21 then transmits the generated first road traffic detection information to the traffic control apparatus 70 through the transceiver 18.

The communication_ECU 21 also receives, through the transceiver 18, road map information (which will be described below) appropriately transmitted from the traffic control apparatus 70.

Herein, the road map information transmitted from the traffic control apparatus 70 refers to map information on which road traffic information which changes from moment to moment is reflected in real time. The road map information is generated based on pieces of information respectively collected from each of the vehicles 5, each of the monitoring apparatuses 50, and the like which are present in a predetermined traffic control area.

Furthermore, the communication_ECU 21 receives, through the transceiver 18, control information (which will be described below) appropriately transmitted from the traffic control apparatus 70. The control information includes, for instance, a target deceleration for executing deceleration control of the vehicle 5 in case of an emergency with a possibility of a collision with an obstacle. When the target deceleration is received, the communication_ECU 21 outputs the received target deceleration to the E/G_ECU 23 and the BK_ECU 25. Thus, the E/G_ECU 23 and the BK_ECU 25 can execute the deceleration control based on the target deceleration as interrupt control.

The control information also includes, for instance, a target steered angle for executing steering control of the vehicle 5 in case of an emergency. When the target steered angle is received, the communication_ECU 21 outputs the received target steered angle to the PS_ECU 24. Thus, the PS_ECU 24 can execute the steering control based on the target steered angle as the interrupt control.

That is, in the present example, each piece of the control information transmitted from the traffic control apparatus 70 is prioritized over control information (which will be described below) computed in the traveling_ECU 22 on the vehicle 5 side.

In this manner, in the present example, the camera unit 11, the acceleration sensor 14, the speed sensor 15, the gyro sensor 16, the GNSS receiver 17, and the like correspond to a specific example which may serve as a first road traffic detection information acquisition unit. The transceiver 18 corresponds to a specific example which may serve as a first communication device. Note that the communication_ECU 21 can also transmit the first road traffic detection information to another vehicle 5 present around the vehicle 5 through the transceiver 18 (see FIG. 2).

The traveling_ECU 22 computes the control information for the vehicle 5 (own vehicle) based on the road map information received from the traffic control apparatus 70. Herein, in the present example, the traveling_ECU 22 computes the control information mainly related to an improvement in convenience for a driver.

For instance, the traveling_ECU 22 computes a target acceleration and deceleration based on the road map information as the control information for the adaptive cruise control (ACC). That is, when it is recognized based on the road map information that a preceding vehicle is present ahead in a traveling lane of the own vehicle, the traveling_ECU 22 computes the target acceleration and deceleration for causing the own vehicle to maintain a predetermined inter-vehicle distance to the preceding vehicle and to perform following traveling. On the other hand, when it is recognized based on the road map information that no preceding vehicle is present ahead in the traveling lane of the own vehicle, the traveling_ECU 22 computes a target acceleration and deceleration for causing the own vehicle to perform constant speed traveling at a set vehicle speed. The traveling_ECU 22 then outputs the computed target acceleration and deceleration to the E/G_ECU 23 and the BK_ECU 25. Thus, the E/G_ECU 23 and the BK_ECU 25 can execute acceleration and deceleration control based on the target acceleration and deceleration.

In addition, for instance, the traveling_ECU 22 computes a target steered angle based on the road map information as the control information for the active lane keep centering (ALKC) control. That is, the traveling_ECU 22 computes, based on the road map information, the target steered angle for causing the own vehicle to keep the center of the traveling lane of the own vehicle. The traveling_ECU 22 then outputs the computed target steered angle to the PS_ECU 24. Thus, the PS_ECU 24 can execute steering control based on the target steered angle.

A throttle actuator 27 is coupled to an output side of the E/G_ECU 23. The throttle actuator 27 opens and closes a throttle valve of an electronic control throttle provided to a throttle body of an engine. That is, the throttle actuator 27 adjusts an intake airflow by opening and closing the throttle valve by a drive signal from the E/G_ECU 23. Thus, the throttle actuator 27 generates a desired engine output.

An electric power steering motor 28 is coupled to an output side of the PS_ECU 24. The electric power steering motor 28 applies a steering torque to a steering mechanism by a rotational force of the motor. That is, the electric power steering motor 28 generates a desired steered angle by a drive signal from the PS_ECU 24.

A brake actuator 29 is coupled to an output side of the BK_ECU 25. The brake actuator 29 adjusts a brake hydraulic pressure supplied to a brake wheel cylinder provided to each wheel. That is, when the brake actuator 29 is driven by a drive signal from the BK_ECU 25, the brake actuator 29 generates a brake force to each wheel through the brake wheel cylinder. Thus, the brake actuator 29 causes the vehicle 5 to forcibly decelerate.

An alarm apparatus 30 is coupled to an output side of the alarm_ECU 26. The alarm apparatus 30 emits a predetermined alarm to the driver. Herein, the alarm apparatus 30 is constituted, for instance, by a multi-information display provided to an installment panel, a speaker, and the like. That is, the alarm apparatus 30 displays a predetermined warning or generates a predetermined alarm sound to the driver by a drive signal from the alarm_ECU 26.

In this manner, in the present example, the E/G_ECU 23, the PS_ECU 24, and the BK_ECU 25 correspond to a specific example which may serve as a driving control execution unit.

The monitoring apparatus 50 is, for instance, a roadside infrastructure which observes a traveling environment. The monitoring apparatus 50 is fixed and disposed at a predetermined interval along the roadside. The monitoring apparatus 50 includes, for instance, a camera unit 51 and a communication_ECU 52.

The camera unit 51 is constituted, for instance, by a single-lens camera. The camera unit 51 is disposed such that, for instance, an optical axis is tilted at an angle of depression from above the roadside towards a road surface. Thus, the camera unit 51 detects image information including a vehicle traveling on the road, and the like.

A transceiver 53 which enables wireless communication with the traffic control apparatus 70 is coupled to the communication_ECU 52. The transceiver 53 is compatible with the highly reliable and low latency communication system (for instance, the 5th generation mobile communication system). The camera unit 51 is coupled to an input side of the communication_ECU 52.

The communication_ECU 52 generates road traffic detection information (second road traffic detection information) including the image information described above which has been input from the camera unit 51. The communication_ECU 52 transmits the generated second road traffic detection information to the traffic control apparatus 70 in every preset control cycle.

Specifically, the communication_ECU 52 generates, for instance, as illustrated in FIG. 5, road traffic detection information including an ID of the monitoring apparatus 50, a transmission date and time, an image, a location (a latitude and a longitude) of the monitoring apparatus 50, and the like. The communication_ECU 52 then transmits the generated road traffic detection information to the traffic control apparatus 70 through the transceiver 53.

In this manner, in the present example, the camera unit 51 corresponds to a specific example which may serve as a second road traffic detection information acquisition unit. The transceiver 53 corresponds to a specific example which may serve as a third communication device.

The traffic control apparatus 70 is, for instance, an edge server (so-called MEC server) in a network environment based on edge computing, and is disposed in each predetermined traffic control area. The traffic control apparatus 70 includes, for instance, a communication_ECU 71, a road traffic information recognition control unit (hereinafter, referred to as an “information recognition_ECU”) 72, and a traveling control unit (hereinafter, referred to as a “traveling_ECU”) 73. These control units 71 to 73 are coupled to each other via a predetermined communication line. Herein, each of the control units 71 to 73 has a higher performance specification than that of each of the control units mounted to the vehicle 5. Note that each of the control units 71 to 73 can also be configured by a single control unit.

A transceiver 74 which enables wireless communication between the driving control apparatus 10 of each vehicle and each of the monitoring apparatuses 50 is coupled to the communication_ECU 71. The transceiver 74 is compatible with the highly reliable and low latency communication system (for instance, the 5th generation mobile communication system).

When the transceiver 74 receives the road traffic detection information from the driving control apparatus 10 of each of the vehicles 5 and from each of the monitoring apparatuses 50, the communication_ECU 71 outputs the received road traffic detection information to the information recognition_ECU 72.

In addition, when control information (which will be described below) of the vehicle is input from the traveling_ECU 73, the communication_ECU 71 transmits the input control information to the relevant vehicle 5 through the transceiver 74.

Furthermore, when the road map information is input from the information recognition_ECU 71, the communication_ECU 72 transmits the input road map information to each of the vehicles 5 through the transceiver 74.

In this manner, in the present example, the transceiver 74 corresponds to a specific example which may serve as a second communication device.

A high-precision road map database 75 is coupled to the information recognition_ECU 72. The high-precision road map database 75 is a large capacity storage medium such as an HDD. The high-precision road map database 75 stores high-precision road map information (dynamic map) as information to be used when traveling control is executed for each of the vehicles 5 traveling on the road. The high-precision road map information has three layers of information including static information which mainly configures road information, and quasi-dynamic information and dynamic information which mainly configure traffic information.

The static information is configured, for instance, by information which demands an update frequency within a month such as a road and a structure on the road, lane information, road surface information, and permanent restriction information.

The quasi-dynamic information is configured, for instance, by information which demands an update frequency within a minute, such as an actual traffic jam situation and a traveling restriction at an observation time point, a temporary traveling issue situation such as a falling object and an obstacle, an actual accident situation, and narrow area weather information.

The dynamic information is configured, for instance, by information which demands an update frequency within a second, such as information transmitted and exchanged between movable objects, information of a currently indicated traffic light, information of a pedestrian and a two-wheeled vehicle at a junction, information of a vehicle going straight on through the junction.

Such road map information is maintained and updated in a cycle until next information is received from the driving control apparatus 10 of each of the vehicles 5 and from each of the monitoring apparatuses 50. The updated information is appropriately output to the communication_ECU 71 and the traveling_ECU 73. Note that all the pieces of the road map information in the traffic control area can also be output as the road map information output to the communication_ECU 71. Note, however, that when load of the communication with the communication_ECU 21 on the vehicle 5 side is taken into account, it is desirable that each of the vehicles 5 extracts only the road map information to be used to compute the control information in the traveling_ECU 22, and the extracted road map information is output as separate road map information associated with the ID of each of the vehicles 5.

Upon the update of the road map information, the information recognition_ECU 72 analyzes the road traffic detection information received from the driving control apparatus 10 of each of the vehicles 5 and from each of the monitoring apparatuses 50. Thus, the information recognition_ECU 72 performs recognition processing of the road traffic information.

For instance, when the road traffic detection information from the driving control apparatus 10 is received, the information recognition_ECU 72 recognizes a current location of the vehicle 5 on the road map, and also recognizes a movement direction, a movement speed, and the like of the vehicle 5.

The information recognition_ECU 72 also acquires, based on the received distance image information and the like, a lane marker which marks out the road around the relevant vehicle 5. The information recognition_ECU 72 also acquires a road curvature [1/m] of each lane marker marking out the left and right of a traveling path and a width (lane width) between each lane marker.

Furthermore, the information recognition_ECU 72 performs predetermined pattern matching and the like on the distance image information. Thus, the information recognition_ECU 72 performs recognition of three-dimensional objects such as a guardrail and a curb which are present along the road, and a pedestrian, a two-wheeled vehicle, and a vehicle other than the two-wheeled vehicle which are present on the road. Herein, in the three-dimensional object recognition in the information recognition_ECU 72, for instance, a type of a three-dimensional object, a distance to the three-dimensional object, a speed of the three-dimensional object, and the like are recognized.

Similarly, when the road traffic detection information from the monitoring apparatus 50 is received, the information recognition_ECU 72 performs well-known image recognition processing and the like based on the received image information and the like. Thus, the information recognition_ECU 72 performs the recognition processing of the road traffic information.

When the road traffic information is recognized as described above based on the road traffic detection information from the driving control apparatus 10 and the monitoring apparatus 50, the information recognition_ECU 72 updates the road map information stored in the high-precision road map database 75 from time to time based on the recognized road traffic information. The information update is performed with regard to not only the static information but also the quasi-dynamic information and the dynamic information. Thus, the road map information includes the latest road traffic information acquired by the communication with the outside of the traffic control apparatus 70, and the information of the movable object such as the vehicle traveling on the road is updated in real time.

In this manner, in the present example, the information recognition_ECU 72 corresponds to a specific example which may serve as a road traffic information recognition unit.

The traveling_ECU 73 computes the control information for each of the vehicles 5 present in the traffic control area of the traffic control apparatus 70. As the control information, the traveling_ECU 73 computes at least control information for each of the vehicles 5 to urgently avoid a collision with an obstacle. Herein, various types of programs for computing the control information and the like in the traveling_ECU 73 can be updated to latest programs from time to time through the network environment NW, for instance.

Specifically, when an obstacle having a high possibility of a collision with the vehicle 5 is detected in a forward area of the traveling path of the vehicle 5 based on the road map information on which the road traffic information has been reflected, the traveling_ECU 73 computes control information for autonomous emergency braking ((AEB): collision damage reducing breaking) control with which the vehicle is to be stopped before reaching the obstacle.

Herein, the obstacle in the present example refers to a three-dimensional object having a possibility of a collision with the vehicle 5. Specifically, the obstacle in the present example has at least a part which is rapped with the vehicle 5 in the forward area of the traveling path of the vehicle 5. The obstacle includes, of course, another vehicle 5 and the like stopping near a shoulder of the road, and also a preceding vehicle 5 which has suddenly decelerated or suddenly stopped in front of the vehicle 5 and a pedestrian who is crossing the traveling path, and the like.

The control information for the autonomous emergency braking control is set based on the obstacle recognized by the information recognition_ECU 72. As the control information for the autonomous emergency braking control, for instance, control information for primary braking control and control information for secondary braking control are set in sequential steps.

The primary braking control is alarming braking control for urging the driver to perform an operation for avoiding a collision with the obstacle. The primary braking control is gentle braking control for decelerating the vehicle 5 by using a relatively small deceleration a0.

The secondary braking control is main braking control which is performed when an appropriate collision avoidance operation is not performed by the driver in response to the primary braking control. The secondary braking control is hard braking control for decelerating the vehicle 5 until the relative velocity with the obstacle becomes “0” by using a deceleration ap which is larger than that of the primary braking control.

The control information for these types of braking control is set when a relationship of a relative velocity Vrel and a relative distance D between the vehicle 5 and the obstacle becomes a threshold or less.

In the present example, specifically, the traveling_ECU 73 calculates braking control start distances D1th and D2th serving as distance thresholds from a relationship of the relative velocity Vrel and a rap rate R between the vehicle 5 and the obstacle. To calculate the distance thresholds D1th and D2th, a map for setting a primary braking control start distance and a map for setting a secondary braking control start distance are set in advance based on an experiment, a simulation, and the like, and are stored in the traveling_ECU 73. Basically, the maps are set such that as the relative velocity Vrel becomes lower, the distance threshold is set at a smaller value to delay deceleration start timing, and also as the rap rate R becomes lower, the distance threshold is set at a smaller value to delay the deceleration start timing. That is, as the relative velocity Vrel becomes lower and also the rap rate R becomes lower, each map has such a setting that a margin is left for the driver to avoid the collision with the obstacle by the driving operation by the driver.

Then, when a relative distance D becomes the primary braking control start distance D1th or less, the traveling_ECU 73 sets the target deceleration a0 as the control information for the vehicle 5.

Furthermore, when an appropriate avoidance operation and the like are not performed by the driver during the primary braking control, and the relative distance D becomes the secondary braking control start distance D2th or less, the traveling_ECU 73 sets the target deceleration ap as the control information for the vehicle 5.

Note that a time to collision TTC which will be described below is a parameter practically synonymous with the relative distance D in the braking control. Therefore, the time to collision TTC can also be used as a parameter indicating the relationship of the relative velocity Vrel and the relative distance D.

During the execution of the secondary braking control, the traveling_ECU 73 also calculates the time to collision TTC that is a period of time for the vehicle 5 to collide with the obstacle. As the time to collision TTC, for instance, a value is calculated by dividing the relative distance D between the vehicle 5 and the front obstacle by the relative velocity Vrel between the vehicle 5 and the front obstacle ((the relative distance D)/(the relative velocity Vrel)).

Then, when the time to collision TTC is a preset threshold Tth or less, the traveling_ECU 73 determines that it is difficult to avoid the collision with the obstacle by the braking control. Thus, to perform emergency avoidance of the collision with the obstacle by steering, the traveling_ECU 73 computes control information for autonomous emergency steering ((AES): automatic steering avoidance) control. Herein, the threshold Tth is a threshold for determining in the relationship with the time to collision TTC whether there is a temporal margin for avoiding the collision between the vehicle 5 and the obstacle by the autonomous emergency braking control.

Upon the sheering control, the traveling_ECU 73 calculates a target lateral location for the vehicle 5 to avoid the collision with the obstacle. The traveling_ECU 73 also sets, for instance, a vehicle location at a time point at which the time to collision TTC becomes the set threshold Tth or less as a control start location. The traveling_ECU 73 also calculates, as a target path for the autonomous emergency steering control, a first target path from the control start location to an intermediate location between the control start location and the target lateral location and a second target path from the intermediate location to the target lateral location. The first target path and the second target path are calculated by using a lateral jerk (rate of change over time of an acceleration) which is allowed depending on a vehicle speed. Then, the traveling_ECU 73 sets a target steered angle for the vehicle 5 to travel along the target path as the control information.

Furthermore, when another vehicle 5 is to be affected by a behavior of the vehicle 5 for which the control information has been set, the traveling_ECU 73 also appropriately computes control information for collision avoidance for the other vehicle 5 when necessary.

Each of the thus computed control information is output from the traveling_ECU 73 to the communication_ECU 71. The communication_ECU 71 transmits each of the control information to the relevant vehicle 5 through the transceiver 74. In this manner, in the present example, the traveling_ECU 73 corresponds to a specific example which may serve as a control information computation unit.

Herein, the traveling_ECU 73 can also set, as the control information, direct control instruction values for various types of actuators in each of the vehicles 5 instead of various types of control target values. That is, the traveling_ECU 73 can also calculate, as the control information for the primary braking control in the autonomous emergency braking control, for instance, a control instruction value (control instruction value obtained by taking into account a feedback correction value and the like) which is output from the E/G_ECU 23 and the BK_ECU 25 to the throttle actuator 27 and the brake actuator 29 instead of the target deceleration a0. The traveling_ECU 73 can also calculate, as the control information for the secondary braking control in the autonomous emergency braking control, for instance, a control instruction value (control instruction value obtained by taking into account the feedback correction value and the like) which is output from the E/G_ECU 23 and the BK_ECU 25 to the throttle actuator 27 and the brake actuator 29 instead of the target deceleration ap. The traveling_ECU 73 can also set, as the control information for the autonomous emergency steering control, for instance, a control instruction value (control instruction value obtained by taking into account the feedback correction value and the like) which is output from the PS_ECU 24 to the electric power steering motor 28 instead of the target steered angle.

Next, a description will be provided in accordance with a flowchart of a communication control routine in the communication_ECU 21 of the driving control apparatus 10. The routine is repeatedly executed in every set cycle in the communication_ECU 21.

When the routine is started, the communication_ECU 21 checks in step S101 whether the vehicle 5 is present in a service area (traffic control area) of the traffic control apparatus 70.

When it is determined in step S101 that the vehicle 5 is out of the service area (step S101: NO), the communication_ECU 21 directly leaves the routine.

On the other hand, when it is determined in step S101 that the vehicle 5 is present in the service area (step S101: YES), the communication_ECU 21 proceeds to step S102. In step S102, the communication_ECU 21 checks whether a set period of time (for instance, 200 msec) has elapsed since the previous transmission of the first road traffic detection information.

When it is determined in step S102 that the set period of time has elapsed (step S102: YES), the communication_ECU 21 proceeds to step S103. In step S103, the communication_ECU 21 transmits the first road traffic detection information through the transceiver 18, and then proceeds to step S104.

On the other hand, when it is determined in step S102 that the set period of time has not elapsed (step S102: NO), the communication_ECU 21 directly proceeds to step S104.

When the communication_ECU 21 proceeds from step S102 or step S103 to step S104, the communication_ECU 21 checks whether the control information is received through the transceiver 18 from the traffic control apparatus 70 corresponding to the traffic control area in which the vehicle 5 is currently present.

When it is determined in step S104 that the control information is not received (step S104: NO), the communication_ECU 21 proceeds to step S109.

On the other hand, when it is determined in step S104 that the control information is received (step S104: YES), the communication_ECU 21 proceeds to step S105. In step S105, the communication_ECU 21 checks whether the received control information includes a target deceleration.

When it is determined in step S105 that the received control information includes the target deceleration (step S105: YES), the communication_ECU 21 proceeds to step S106. In step S106, the communication_ECU 21 outputs the target deceleration to the E/G_ECU 23, the BK_ECU 25, and the alarm_ECU 26, and then proceeds to step S107. Thus, the E/G_ECU 23 and the BK_ECU 25 execute the autonomous emergency breaking control with regard to the obstacle based on the input target deceleration. The alarm_ECU 26 appropriately executes predetermined alarm control according to the target deceleration.

On the other hand, when it is determined in step S105 that the received control information does not include the target deceleration (step S105: NO), the communication_ECU 21 directly proceeds to step S107.

When the communication_ECU 21 proceeds from step S105 or step S106 to step S107, the communication_ECU 21 checks whether the received control information includes a target steered angle.

When it is determined in step S107 that the received control information includes the target steered angle (step S107: YES), the communication_ECU 21 proceeds to step S108. In step S108, the communication_ECU 21 outputs the target steered angle to the PS_ECU 24 and the alarm_ECU 26, and then proceeds to step S109. Thus, the PS_ECU 24 executes the autonomous emergency steering control with regard to the obstacle based on the input target steered angle. The alarm_ECU 26 appropriately executes the predetermined alarm control according to the target steered angle.

On the other hand, when it is determined in step S107 that the received control information does not include the target steered angle (step S107: NO), the communication_ECU 21 directly proceeds to step S109.

When the communication_ECU 21 proceeds from step S107 or step S108 to step S109, the communication_ECU 21 checks whether the road map information is received from the traffic control apparatus 70 corresponding to the traffic control area in which the vehicle 5 is currently present through the transceiver 18.

When it is determined in step S109 that the road map information is not received (step S109: NO), the communication_ECU 21 directly leaves the routine.

On the other hand, when it is determined in step S109 that the road map information is received (step S109: YES), the communication_ECU 21 proceeds to step S110. In step S110, the communication_ECU 21 outputs the received road map information to the traveling_ECU 22, and then leaves the routine.

Note that although the detailed description will be omitted, but the communication_ECU 52 of the monitoring apparatus 50 also performs processing similar to step S102 and step S103 described above. Thus, the second road traffic detection information is transmitted to the traffic control apparatus 70.

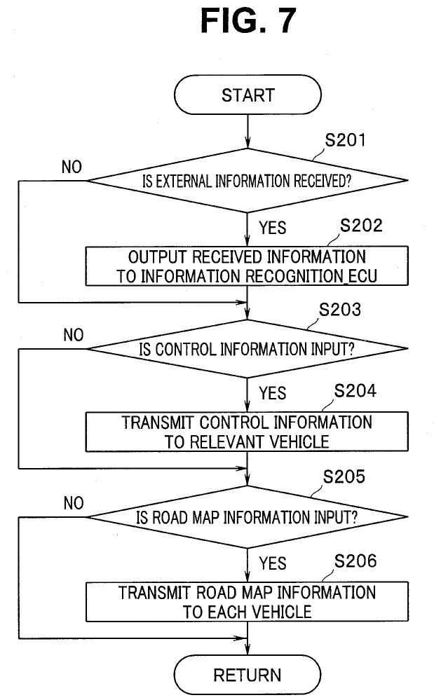

Next, communication control executed in the communication_ECU 71 of the traffic control apparatus 70 will be described in accordance with a flowchart of a communication control routine in FIG. 7. The routine is repeatedly executed in every set cycle in the communication_ECU 71.

When the routine is started, the communication_ECU 71 checks in step S201 whether external information is received. That is, the communication_ECU 71 checks whether at least either one of the first road traffic detection information from the driving control apparatus 10 of the vehicle 5 present in the traffic control area and the second road traffic detection information from the monitoring apparatus 50 is received.

When it is determined in step S201 that the external information is received (step S201: YES), the communication_ECU 71 proceeds to step S202. In step S202, the communication_ECU 71 outputs the received information to the information recognition_ECU 72, and then proceeds to step S203.

On the other hand, when it is determined in step S201 that the external information is not received (step S201: NO), the communication_ECU 71 directly proceeds to step S203.

When the communication_ECU 71 proceeds from step S201 or step S202 to step S203, the communication_ECU 71 checks whether the control information is input from the traveling_ECU 73.

When it is determined in step S203 that the control information is input (step S203: YES), the communication_ECU 71 proceeds to step S204. In step S204, the communication_ECU 71 transmits the input control information to the vehicle 5 having an ID relevant to the control information through the transceiver 74, and then proceeds to step S205.

On the other hand, when it is determined in step S203 that the control information is not input (step S203: NO), the communication_ECU 71 directly proceeds to step S205.

When the communication_ECU 71 proceeds from step S203 or step S204 to step S205, the communication_ECU 71 checks whether the newly updated road map information is input from the information recognition_ECU 72.

When it is determined in step S205 that the road map information is input (step S205: YES), the communication_ECU 71 proceeds to step S206. In step S206, the communication_ECU 71 transmits the input road map information to each of the vehicles 5 in the traffic control area, and then leaves the routine.

On the other hand, when it is determined in step S205 that the road map information is not input (step S205: NO), the communication_ECU 71 directly leaves the routine.

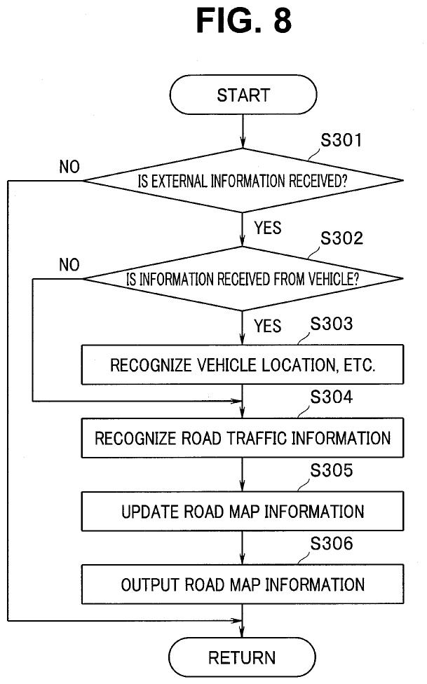

Next, road traffic information recognition processing performed in the information recognition_ECU 72 will be described in accordance with a flowchart of a road traffic information recognition routine illustrated in FIG. 8. The routine is repeatedly executed in every set cycle in the information recognition_ECU 72.

When the routine is started, the information recognition_ECU 72 checks whether external information is input through the communication_ECU 71.

When it is determined in step S301 that the external information is not input (step S301: NO), the information recognition_ECU 72 directly leaves the routine.

On the other hand, when it is determined in step S301 that the external information is input (step S301: YES), the information recognition_ECU 72 proceeds to step S302. In step S302, the information recognition_ECU 72 checks whether the input information is information from the vehicle 5. That is, the information recognition_ECU 72 checks whether the input information is the first road traffic detection information.

When it is determined in step S302 that the input information is the information from the vehicle 5 (step S302: YES), the information recognition_ECU 72 proceeds to step S303. Then, in step S303, the information recognition_ECU 72 recognizes a current location of the vehicle 5 on the road map, a travel direction of the vehicle 5, a speed of the vehicle 5, and the like based on the first road traffic detection information, and then proceeds to step S304.

On the other hand, when it is determined in step S302 that the input information is not the information from the vehicle 5 (step S302: NO), that is, when it is determined that the input information is the second road traffic detection information, the information recognition_ECU 72 directly proceeds to step S304.

When the information recognition_ECU 72 proceeds from step S302 or step S303 to step S304, the information recognition_ECU 72 performs recognition of the road traffic information based on the input road traffic detection information.

For instance, when the recognition of the road traffic information based on the first road traffic detection information is performed, the information recognition_ECU 72 sets the vehicle location, the travel direction, and the like which are recognized in step S303 as references, and performs the recognition of various types of information including the lane marker, the lane width, the three-dimensional objects such as the other vehicle and the pedestrian, and the like, on the road. Furthermore, the information recognition_ECU 72 recognizes movement speeds of various types of the three-dimensional objects and the like based on the relative velocity with the vehicle 5.

On the other hand, for instance, when the recognition of the road traffic information based on the second road traffic detection information is performed, the information recognition_ECU 72 sets coordinates of the monitoring apparatus 50 and an optical axis direction of the camera unit 51 as references, and performs the recognition of various types of information including the lane marker, the lane width, the three-dimensional objects such as the other vehicle and the pedestrian, and the like, on the road. Furthermore, the information recognition_ECU 72 recognizes movement speeds of various types of the three-dimensional objects and the like.

When the information recognition_ECU 72 proceeds from step S304 to step S305, the information recognition_ECU 72 uses the road traffic information recognized in step S304 and the like to update the road map information, and then proceeds to step S306.

When the information recognition_ECU 72 proceeds from step S305 to step S306, the information recognition_ECU 72 outputs the road map information updated in step S305 to the communication_ECU 71 and the traveling_ECU 73, and then leaves the routine.

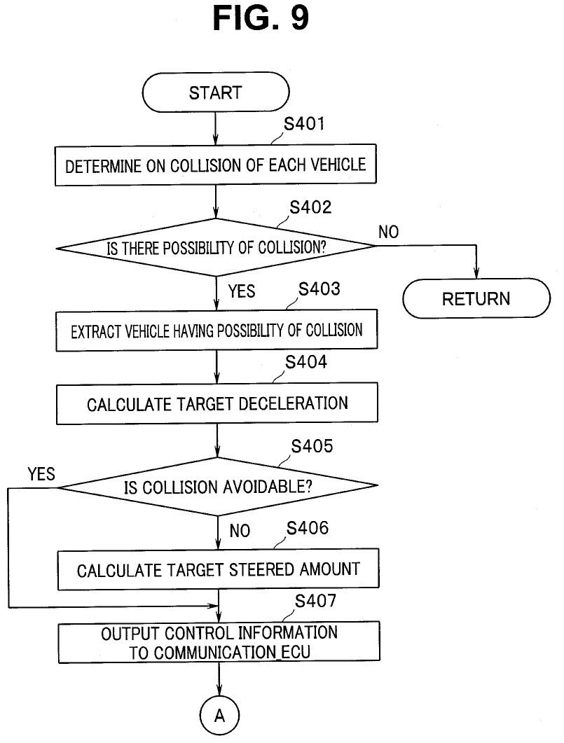

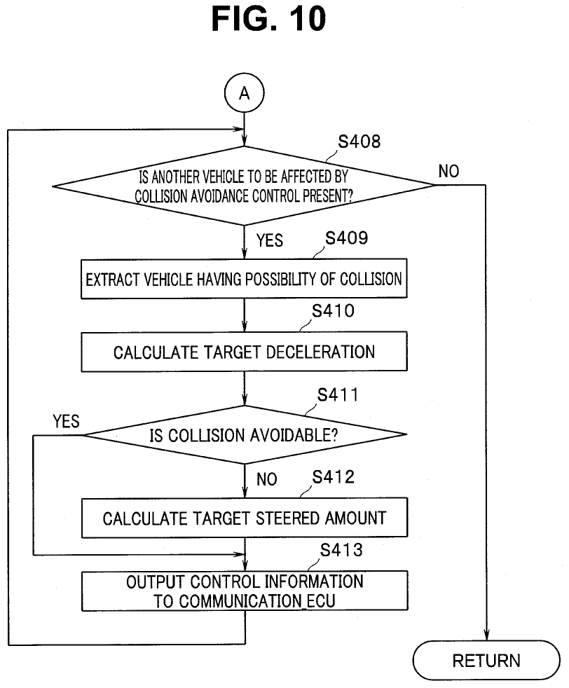

Next, computation processing of the control information for each of the vehicles 5 which is performed in the traveling_ECU 73 of the traffic control apparatus 70 will be described in accordance with a flowchart of a control information computation routine illustrated in FIGS. 9 and 10. The routine is repeatedly executed in every set cycle in the traveling_ECU 73.

When the routine is started, the traveling_ECU 73 determines in step S401 whether there is a possibility for each of the vehicles 5 present in the traffic control area to collide with an obstacle based on the road traffic information (more specifically, based on the road map information on which the latest road traffic information has been reflected).

Then, in step S402, as a result of the determination in step S401 described above, it is checked whether the vehicle 5 having a possibility of the collision with the obstacle is present.

When it is determined in step S402 that the vehicle 5 having a possibility of the collision with the obstacle is absent (step S402: NO), the traveling_ECU 73 directly leaves the routine.

On the other hand, when it is determined in step S402 that the vehicle 5 having a possibility of the collision with the obstacle is present (step S402: YES), the traveling_ECU 73 proceeds to step S403. In step S403, the traveling_ECU 73 extracts the vehicle 5 having the possibility of the collision from among the vehicles 5 present in the traffic control area.

Then, in step S404, as the control information for each of the vehicles 5 extracted in step S403, a target deceleration is individually calculated for each of the vehicles 5 to avoid the collision with the obstacle by the autonomous emergency breaking control.

Then, in step S405, the traveling_ECU 73 checks whether the collision with the obstacle is avoidable by the autonomous emergency breaking control with regard to each of the vehicles 5.

When it is determined in step S405 that the collision with the obstacle is avoidable by the autonomous emergency breaking control (step S405: YES), the traveling_ECU 73 directly proceeds to step S407.

On the other hand, when it is determined in step S405 that the collision with the obstacle is not avoidable by the autonomous emergency breaking control (step S405: NO), the traveling_ECU 73 individually calculates, in step S406 and as the control information for the relevant vehicle 5, a target steered angle (target steered amount) for each of the vehicles 5 to avoid the collision with the obstacle by the autonomous emergency steering control.

When the traveling_ECU 73 proceeds from step S405 or step S406 to step S407, the traveling_ECU 73 outputs the control information calculated with regard to each of the vehicles 5 to the communication_ECU 71, and then proceeds to step S408.

When the traveling_ECU 73 proceeds from step S407 to step S408, the traveling_ECU 73 checks whether another vehicle 5 to be affected when the collision avoidance control of the relevant vehicle 5 is executed based on the control information described above is present in the traffic control area. That is, the traveling_ECU 73 checks whether when the collision avoidance control of the vehicle 5 is executed based on the control information described above, another vehicle 5 having a possibility of a collision with the vehicle 5 which has executed the collision avoidance control is newly generated.

When it is determined in step S408 that another vehicle 5 that is affected is absent (step S408: NO), the traveling_ECU 73 directly leaves the routine.

On the other hand, when it is determined in step S408 that another vehicle 5 that is affected is present (step S408: YES), the traveling_ECU 73 proceeds to step S409. In step S409, the traveling_ECU 73 extracts the vehicle 5 newly having the possibility of the collision.

When the traveling_ECU 73 proceeds from step S409 to step S410, in processing in step S410 to step S413, the traveling_ECU 73 performs processing similar to the processing in step S404 to step S407 described above on each of the extracted vehicles 5, and then returns to step S408.

According to such an example, the driving control system 1 for vehicle includes the camera unit 11 mounted to the vehicle 5, the transceiver 18 mounted to the vehicle 5, the camera unit 51 provided to the monitoring apparatus 50 fixed and disposed along the roadside, and the transceiver 53 provided to the monitoring apparatus 50. The driving control system 1 also includes the transceiver 74 provided to the traffic control apparatus 70 disposed in each traffic control area, the information recognition_ECU 72 which is provided to the traffic control apparatus 70 and recognizes the road traffic information based on the first road traffic detection information received by the transceiver 74 through the transceiver 18 and the second road traffic detection information received by the transceiver 74 through the transceiver 53, and the traveling_ECU 73 provided to the traffic control apparatus 70 and computes the control information of the vehicle 5 present in the traffic control area based on the road traffic information. The driving control system 1 also includes the E/G_ECU 23, the PS_ECU 24, and the BK_ECU 25 which are mounted to the vehicle 5 and execute the driving control based on the control information received by the transceiver 18 through the transceiver 74. Thus, the latest driving control can be deployed to the vehicles 5 of various types of specifications without mounting a complicated system to the vehicles 5.

That is, the information recognition_ECU 72 of the traffic control apparatus 70 comprehensively recognizes the road traffic information in the traffic control area based on the first and second road traffic detection information transmitted from the driving control apparatus 10 of each of the vehicles 5 and from each of the monitoring apparatuses 50. Thus, the information recognition_ECU 72 can precisely and efficiently recognize the road traffic information around the vehicle 5. Then, the traveling_ECU 73 of the traffic control apparatus 70 computes the control information (control parameter) for each of the vehicles 5 based on the road traffic information recognized in the information recognition_ECU 72. Thus, it is not necessary to provide multiple autonomous sensors and the like to the individual vehicles 5, and it is also not necessary to mount a high performance control unit and the like to the individual vehicles 5. Therefore, the system on the vehicle 5 side can be remarkably simplified.

In addition, since the computation of the control information for each of the vehicles 5 is performed in the traveling_ECU 73 of the traffic control apparatus 70, version upgrade of the program and the like for computing the control information and the like is facilitated, and the latest driving control can be deployed to the vehicles 5 of the respective specifications.

In this case, each of the vehicles 5 includes at least one autonomous sensor such as the camera unit 11. Thus, it is also possible for the information recognition_ECU 72 to accurately recognize rushing-out of a pedestrian and the like which may be difficult to sense by the monitoring apparatus 50.

In addition, since the transceiver compatible with the highly reliable and low latency communication system (such as the 5th generation mobile communication system) is adopted for each of the transceivers 18, 53, and 74, it is possible to suppress a delay by the communication to a very small delay. Thus, the road traffic information can be recognized in real time, and furthermore, the control information based on the road traffic information recognized in real time can be reflected on each of the vehicles 5 in real time.

The traveling_ECU 73 also computes the control information for the collision avoidance and the like when necessary for the other vehicle 5 which is to be affected by the behavior of the relevant vehicle 5 in which the control information has been set. Thus, the control with respect to the collision avoidance and the like for the other vehicle 5 can be quickly executed. That is, the computation of the control information for each of the vehicles 5 present in the traffic control area is collectively performed in the traveling_ECU 73 in the traffic control apparatus 70. Thus, for instance, before the relevant vehicle 5 in which the control information has been set actually initiates the behavior for the collision avoidance and the like, the affect caused by the relevant vehicle 5 on the other vehicle 5 can be grasped in advance from the control information for the relevant vehicle 5. Therefore, it is possible to compute the control information for the other vehicle 5 in advance, and the control with respect to the collision avoidance and the like for the other vehicle 5 can be achieved with good responsiveness.

Herein, according to the above-described example, the communication_ECU 21, the traveling_ECU 22, the E/G_ECU 23, the PS_ECU 24, the BK_ECU 25, the alarm_ECU 26, the communication_ECU 52, the communication_ECU 71, the information recognition_ECU 72, the traveling_ECU 73, and the like are configured by a well-known microcomputer including a CPU, a RAM, a ROM, a nonvolatile storage unit, and the like, and its peripheral equipment. The ROM stores fixed data and the like of a program executed by the CPU, a data table, and the like in advance. Note that all or some of functions of a processor may be configured by a logic circuit or an analog circuit. The processing of various types of programs may also be achieved by an electronic circuit such as an FPGA.

The technology described in the above-described example is not limited to the example, and in addition to the above, various types of modifications may be able to implement in a practical phase within a scope without departing from a gist of the technology.

For instance, according to the above-described example, a configuration where the camera unit 11 constituted by the stereo camera is mounted to the vehicle 5 has been described, but the technology is not limited to this. For instance, a camera unit constituted by a single-lens camera, a millimeter wave radar, a light detection and ranging (Lidar), and the like can also be applied instead of the camera unit constituted by the stereo camera. Similarly, in the monitoring apparatus 50, a camera unit constituted by a stereo camera, a millimeter wave radar, a Lidar, and the like can also be applied instead of the camera unit 51 constituted by the single-lens camera.

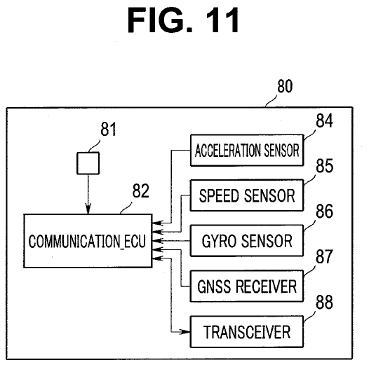

Furthermore, for instance, as illustrated in FIG. 11, a communication terminal 80 such as a smartphone and a mobile phone can be adopted as the movable object which provides the first road traffic detection information to the traffic control apparatus 70.

In this case, the communication terminal 80 includes, as a first road traffic detection acquisition unit, a camera unit 81, an acceleration sensor 84, a speed sensor 85, a gyro sensor 86, a GNSS receiver 87, and the like which are coupled to a communication_ECU 82. The communication terminal 80 also includes, as a first communication device, a transceiver 88 coupled to the communication_ECU 82.

Note that the camera unit 81, the acceleration sensor 84, the speed sensor 85, the gyro sensor 86, the GNSS receiver 87, and the like are components corresponding to the camera unit 11, the acceleration sensor 14, the speed sensor 15, the gyro sensor 16, the GNSS receiver 17, and the like in the above-described example. In addition, the communication_ECU 82 is a component corresponding to the communication_ECU 21 in the above-described example. Furthermore, the transceiver 88 is a component corresponding to the transceiver 18 in the above-described example. Therefore, detailed descriptions of these respective components will be omitted.

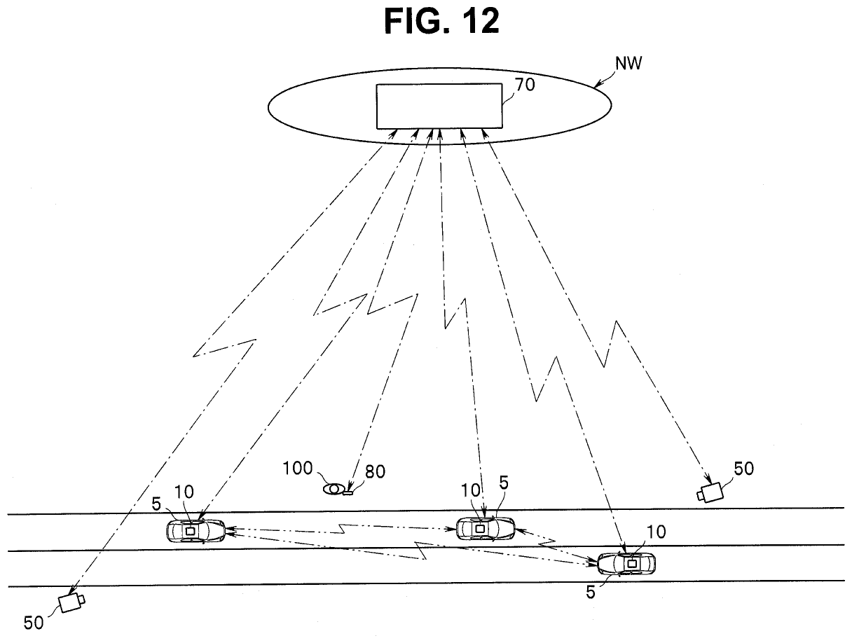

For instance, as illustrated in FIG. 12, since the communication terminal 80 described above is held by a pedestrian 100 and the like in the traffic control area, the communication terminal 80 can acquire the first road traffic detection information, and transmit the acquired first road traffic detection information to the traffic control apparatus 70.

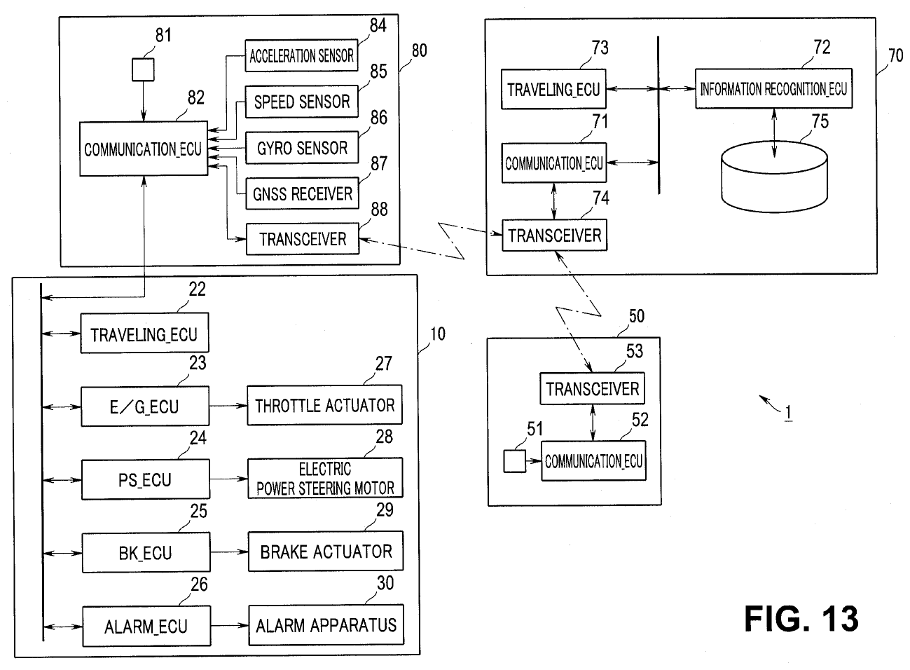

In addition, for instance, as illustrated in FIG. 13, the communication terminal 80 can be applied to the vehicle 5 including the driving control apparatus 10 which does not include a camera unit, a transceiver, and the like. In this case, the communication terminal 80 fixed to a dashboard of the vehicle 5 and the like can be coupled to the driving control apparatus 10 via a communication cable such as a universal serial bus (USB) cable. Thus, the communication terminal 80 can acquire the first road traffic detection information, and transmit the acquired first road traffic detection information to the traffic control apparatus 70. The communication terminal 80 can also output the control information received from the traffic control apparatus 70 to each of the ECUs 23 to 26.

In addition, according to the above-described example, a configuration has been described where only the control information related to the safety of each vehicle is computed in the traffic control apparatus, and the control information of the control for the convenience such as cruise control is computed in the traveling control unit separately provided to each vehicle. However, the technology is not limited to this. For instance, the control information and the like for the convenience may also be computed in the traffic control apparatus. In this case, the traveling_ECU and the like provided to the driving control apparatus of each vehicle can be appropriately omitted.

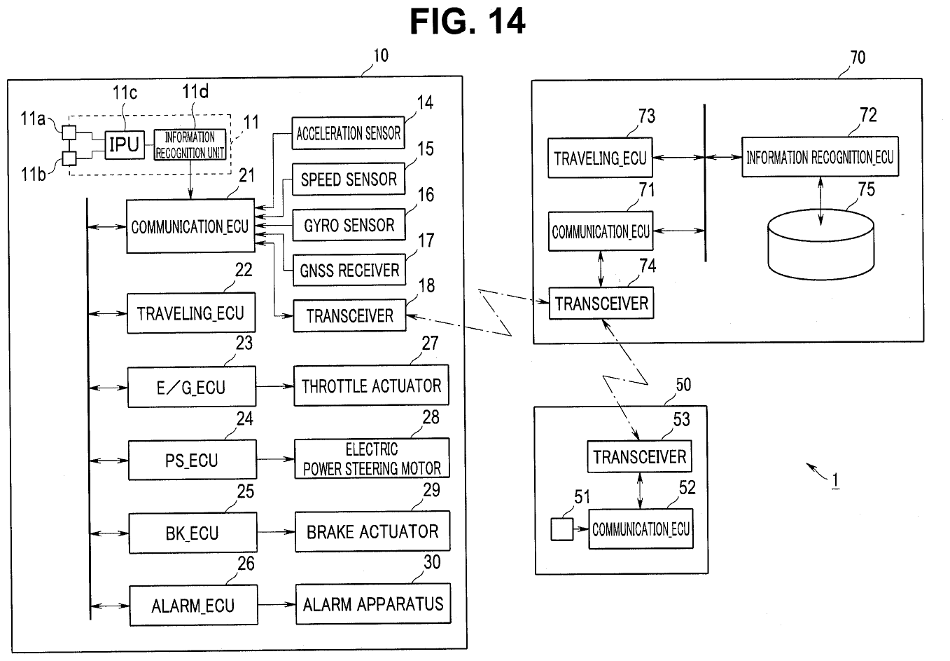

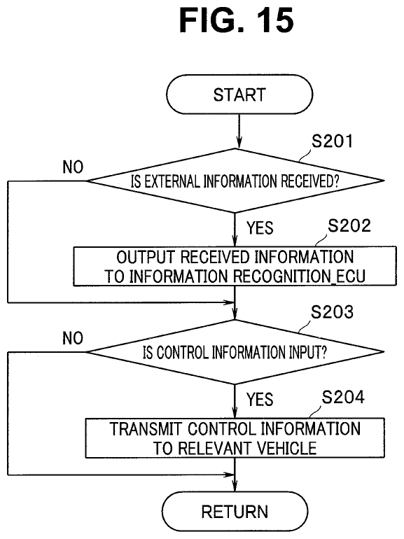

Next, a second example of the technology will be described with reference to FIG. 14 and FIG. 15. Note that components similar to those of the above-described first example are assigned with the same reference numerals, and descriptions thereof will be appropriately omitted.

The present example is an example in which the information transmitted from the transceiver 74 of the traffic control apparatus 70 to the transceiver 18 of the driving control apparatus 10 is to be reduced.

Specifically, in the present example, the information transmitted from the transceiver 74 of the traffic control apparatus 70 to the transceiver 18 of the driving control apparatus 10 is only the control information related to the safety assurance of the vehicle 5 (for instance, the autonomous emergency breaking control and the autonomous emergency steering control with regard to the obstacle).

That is, in the present example, the transmission of the road map information from the transceiver 74 to the transceiver 18 is not basically performed. For instance, as illustrated in FIG. 15, the communication_ECU 71 of the traffic control apparatus 70 performs only the processing in step S201 to step S204 according to the above-described first example.

Thus, for instance, in the vehicle 5 including a driving assist control function for an improvement in the convenience, an information recognition unit 11d which recognizes the road traffic information based on the distance image information generated in the IPU 11c is provided to the camera unit 11.

The information recognition unit 11d performs, for instance, based on the distance image information and the like, calculation of a lane marker which marks out a road around the vehicle 5, calculation of a road curvature of each lane marker marking out the left and right of a traveling path and a lane width, and the like. The information recognition unit 11d also performs, for instance, predetermined pattern matching and the like on the distance image information to perform recognition processing for various types of three-dimensional objects.

The road traffic information recognized in the information recognition unit 11d in this manner is output to the traveling_ECU 22. Then, the traveling_ECU 22 computes, based on the road traffic information input from the information recognition unit 11d, for instance, the control information for the adaptive cruise control, the active lane keep centering control, and the like.

Note that in the present example in which the road traffic information from the traffic control apparatus 70 is not transmitted, as a component which recognizes the road traffic information, in addition to the camera unit 11 or instead of the camera unit 11, an autonomous sensor such as a millimeter wave radar and a laser radar, a locator unit including the road map information independent from the road map information of the traffic control apparatus 70, and the like can be also appropriately provided.

According to such an example, the information transmitted from the transceiver 74 of the traffic control apparatus 70 to the transceiver 18 of the vehicle 5 is limited to the control information for the safety assurance of the vehicle 5. Thus, the load of the communication from the transceiver 74 to the transceiver 18 can be significantly reduced. Therefore, the control information highly precisely computed in the traveling_ECU 73 of the traffic control apparatus 70 can be instantly transmitted to the target vehicle 5, and the control for the safety assurance of the vehicle 5 can be achieved at a higher level.

That is, for instance, also when the traveling control based on the control information computed in the traveling_ECU 22 of the driving control apparatus 10 is executed, the collision avoidance control based on the control information transmitted from the traffic control apparatus 70 can be quickly executed as the interrupt control.

Note that the configurations of the above-described respective examples and the modification can be appropriately combined with each other. Even when some elements are deleted from all elements illustrated in the above-described respective examples and the modification, in a case where the stated issue can be addressed, and the stated advantage can be attained, the configuration without the relevant element may be extracted as the technology. For instance, according to each of the above-described examples, the vehicle 5 including the traveling_ECU 22 in the driving control apparatus 10 has been exemplified, but the control for the safety assurance based on the control information from the traffic control apparatus 70 can also be executed for the vehicle 5 which does not include the traveling_ECU 25.

The present application claims priority from Japanese Patent Application No. 2020-219596 filed on Dec. 28, 2020, the entire contents of which are hereby incorporated in the specification, the scope of claims, and the drawings herein by reference.

1. A driving control system for vehicle, the driving control system comprising:
a first road traffic detection information acquisition unit which is provided to a movable object and configured to acquire first road traffic detection information;
a first communication device provided to the movable object;
a second communication device provided to a traffic control apparatus disposed in each traffic control area;
a road traffic information recognition unit which is provided to the traffic control apparatus and configured to recognize road traffic information based on the first road traffic detection information received by the second communication device through the first communication device;
a control information computation unit which is provided to the traffic control apparatus and configured to compute, as control information for a vehicle present in the traffic control area and based on the road traffic information, at least a target value or a control instruction value of control for the vehicle to urgently avoid a collision with an obstacle; and
a driving control execution unit which is mounted to the vehicle and configured to execute driving control based on the control information received by the first communication device through the second communication device.

2. (canceled)

3. A driving control apparatus for vehicle, the driving control apparatus comprising:
a road traffic detection information acquisition unit configured to acquire road traffic detection information;
a communication device configured to transmit the road traffic detection information to a traffic control apparatus disposed in each traffic control area and to receive control information computed in the traffic control apparatus so as to include at least a target value or a control instruction value of control for a vehicle to urgently avoid a collision with an obstacle; and
a driving control execution unit configured to execute driving control based on the control information.

4. The driving control system for vehicle according to claim 1, wherein the control information computation unit computes, as the control information, a target deceleration for the vehicle to avoid the collision with the obstacle by autonomous emergency breaking control, and when the collision of the vehicle with the obstacle is not avoidable by the autonomous emergency breaking control, the control information computation unit further calculates a target steered angle for the vehicle to avoid the collision with the obstacle by autonomous emergency steering control.

5. The driving control system for vehicle according to claim 1, wherein when another vehicle is to be affected by a behavior of the vehicle for which the control information has been computed, the control information computation unit also computes the control information for collision avoidance for the other vehicle when necessary.

6. The driving control system for vehicle according to claim 1, wherein the driving control execution unit executes the driving control by prioritizing the control information received by the first communication device through the second communication device over control information related to an improvement in convenience for a driver separately calculated in the vehicle.
